(19) United States
(12) Patent Application Publication
(10) Pub. No.: US 2007/0153135 A1
(43) Pub. Date: Jul. 5, 2007

(54) Device for reducing power consumption in display system using diffractive optical modulator

(75) Inventors: Kyu Bum Han, Yongin-si (KR); Seung Woo Lee, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon-si (KR)

(21) Appl. No.: 11/642,609

(22) Filed: Dec. 19, 2006

(30) Foreign Application Priority Data
Dec. 19, 2005 (KR) 10-2005-0125243
Sep. 25, 2006 (KR) 10-2006-0092955

(51) Int. Cl. H04N 5/74; H04N 5/08; G02F 1/00; G06F 3/038; G09G 5/00; G09G 3/18

(52) U.S. Cl. 348/759; 345/211; 345/53; 345/52; 348/533

(57) ABSTRACT

Disclosed herein is a device for reducing power consumption in a display system using a diffractive optical modulator. The device includes a video input unit for receiving video signals, a noise elimination unit for eliminating noise from the video signals and then outputting noise-free video signals when the video signals are input from the video input unit, a drive signal control unit for outputting drive control signals for driving the diffractive optical modulator in response to the video signals input from the noise elimination unit, and a drive integrated circuit for outputting drive signals for driving the diffractive optical modulator and thus generating video images when the drive control signals of the diffractive optical modulator are input from the drive signal control unit.

### CROSS REFERENCE TO RELATED APPLICATION(S)

This application claims the benefit of Korean Patent Application No. 10-2005-0125243, filed Dec. 19, 2005, entitled “Power saving apparatus in display system using diffraction optical modulator and method thereof”, and of Korean Patent Application No. 10-2006-0092955, filed Sep. 25, 2006, entitled “Power saving apparatus in display system using diffraction optical modulator”, which is hereby incorporated by reference in its entirety into this application.

### BACKGROUND OF THE INVENTION

1. Field of the Invention

The present invention relates to a device for reducing power consumption in a display system using a diffractive optical modulator, which compares the video signal of a specific pixel with the video signal of an adjacent pixel, determines that noise exists if an abrupt change in the video signal is detected, and eliminates the noise, with the result that unnecessary switching operation due to noise is suppressed, thereby reducing power consumption.

2. Description of the Related Art

Recently, the micromachining technology for manufacturing micro optical parts, such as micromirrors, microlenses and switches, micro inertia sensors, micro biochips and micro Radio Frequency (RF) communication elements through a semiconductor device manufacturing process has been developed.

An example of such a micromirror is a reflective-type deformable grating optical modulator 10 shown in FIG. 1. The optical modulator 10 is disclosed in U.S. Pat. No. 5,311,360. The modulator 10 has a reflective surface, and includes deformable reflective ribbons 18 that are regularly spaced apart from each other and are suspended over a silicon substrate 16. An insulating layer 11 is deposited on the silicon substrate 16. Thereafter, a sacrificial silicon dioxide layer 12 and a silicon nitride layer 14 are deposited thereon.

The nitride layer 14 is patterned using the ribbons 18, and part of the silicon dioxide layer 12 is etched, so that the ribbons 18 are held over the oxide spacer layer 12 by a nitride frame 20.

To modulate light having a single wavelength of λ₀, the modulator is designed such that the thickness of the ribbons 18 and the thickness of the oxide spacer 12 are λ₀/4 each.

The amplitude of vibration of the grating of the modulator 10, which is limited to the vertical distance d between the reflective surface 22 on the ribbons 18 and the reflective surface of the substrate 16, is controlled by applying voltage between the ribbons 18 (the reflective surface 22 of the ribbons 16 that functions as a first electrode) and the substrate 16 (the conductive layer 24 that is located below the substrate 16 and functions as a second electrode).

Meanwhile, diffractive optical modulators may be used in various applications. For example, the diffractive optical modulator may be used in a large screen projector, particularly a digital image projector, an image projection device for a computer, or a portable terminal.

In these various applications, noise existing in input images may have various forms. In particular, image processing by a portable terminal takes place in an environment in which the processing is easily affected by noise that is generated on transmission and reception paths or through a video coding or decoding process, compared to those in a television.

Among the above various types of noise, salt and pepper noise existing in video signals is generated due to various sources, such as the loss of data, the addition of an unnecessary external noise component and problems with a video capturing device. As seen from the comparison of the noise-free video of FIG. 3A with the noise containing video of FIG. 3B, salt and pepper noise includes spots.

The above-described salt and pepper noise causes a rapid increase in transistor switching current in the drive IC, which in turn increases power consumption.

Referring to FIGS. 4A to 4C, FIG. 4A is a view showing an image in which a large amount of salt and pepper noise exists, and thus changes in gray level exist due to its spot property, FIG. 4B is a view showing a black image, which represents a minimal gray level, and FIG. 4C is a view showing a white image, which represents a maximal gray level. Average digital power consumption at the switching transistor is, on the basis of effective current, highest in the case where spot type noise exists, as shown in FIG. 3B, is high in the case of white video of FIG. 3B, and is lowest in the case of black video of FIG. 3C.

Meanwhile, the display application of a portable terminal, a power source must be provided in view of product characteristics and power consumption must be minimized as much as possible for long term use. Accordingly, in the display application of the portable terminal, such noise needs to be eliminated.

### SUMMARY OF THE INVENTION

Accordingly, the present invention has been made keeping in mind the above problems occurring in the prior art, and an object of the present invention is to provide a device for reducing power consumption in a display system using a diffractive optical modulator, which is capable of reducing power consumption by suppressing the switching of a drive IC.

In order to accomplish the above object, the present invention provides a device for reducing power consumption in a display system using a diffractive optical modulator, including a video input unit for receiving video signals; a noise elimination unit for eliminating noise from the video signals and then outputting noise-free video signals when the video signals are input from the video input unit; a drive signal control unit for outputting drive control signals for driving the diffractive optical modulator in response to the video signals input from the noise elimination unit; and a drive IC for outputting drive signals for driving the diffractive optical modulator and thus generating video images when the drive control signals of the diffractive optical modulator are input from the drive signal control unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the construction of a prior art reflective-type deformable grating optical modulator;

FIG. 2 is a sectional view of a recess-type thin-film piezoelectric optical modulator;

FIG. 3A is a view showing an image in which noise does not exist, and FIG. 3B is a view showing an image in which salt and pepper noise exists;

FIG. 4A is a view showing an image in which salt and pepper noise exists, FIG. 4B is a view showing a black image, and FIG. 4C is a view showing a white image;

FIG. 5 is a block diagram showing the construction of a display system using a single-panel diffractive optical modulator, which has a function of reducing power consumption, according to an embodiment of the present invention;

FIG. 6 is a block diagram showing the construction of the electronic system of FIG. 5;

FIG. 7 is a block diagram showing the internal construction of the noise elimination unit of FIG. 6;

FIG. 8A is a diagram illustrating an embodiment of a sub mask that is used by the mask operation unit of FIG. 7, and FIG. 8B is a diagram illustrating an operation that is performed by the mask operation unit of FIG. 7;

FIG. 9 is a flowchart showing the noise elimination process of the noise elimination unit of FIG. 6; and

FIGS. 10A and 10B are diagrams showing the elimination of noise according to an embodiment of the present invention.

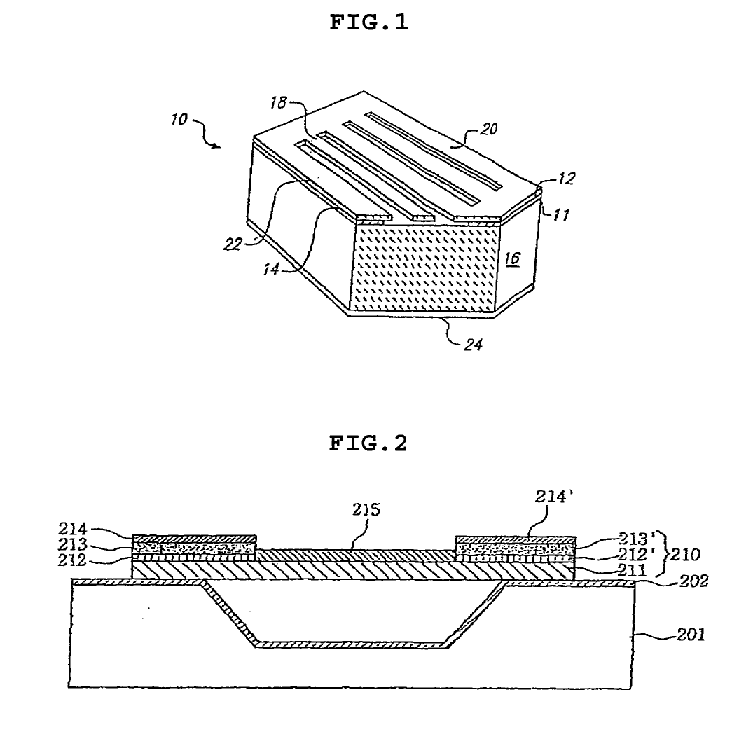

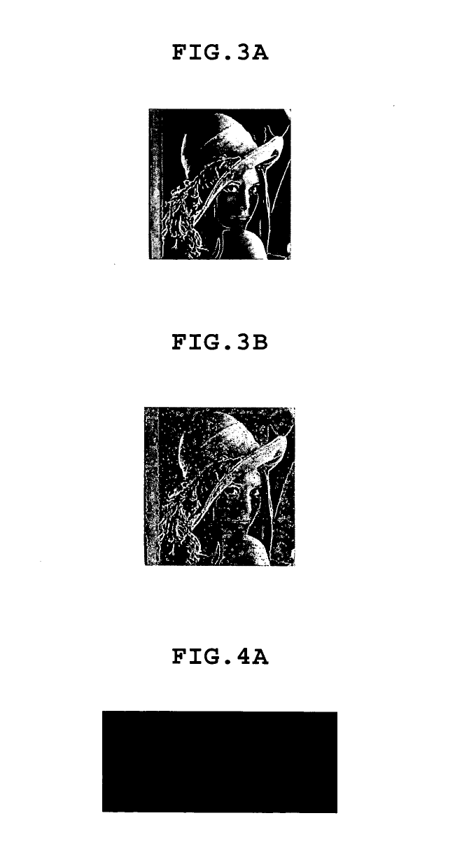

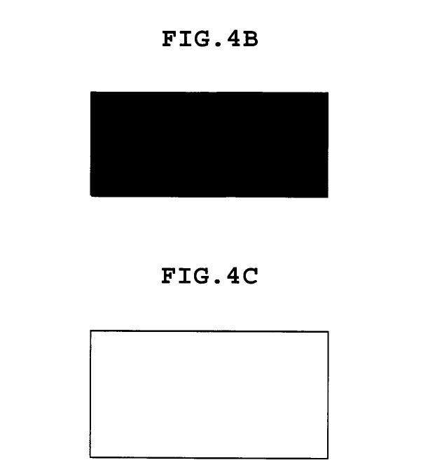

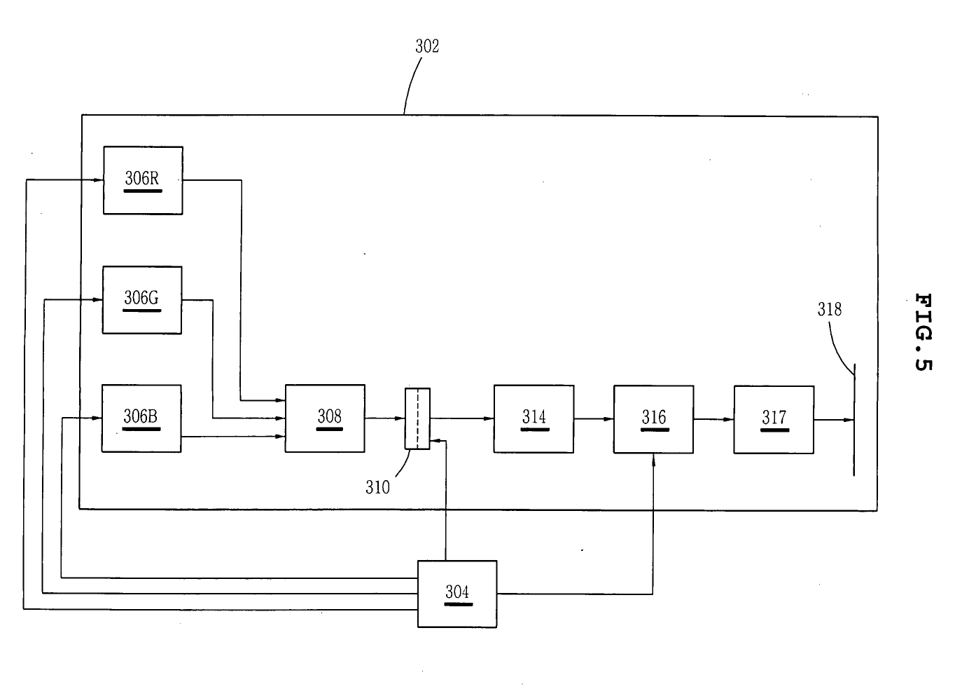

### DESCRIPTION OF THE PREFERRED EMBODIMENTS

Reference now should be made to the drawings, in which the same reference numerals are used throughout the different drawings to designate the same or similar components.

With reference to the accompanying drawings, a preferred embodiment of the present invention is described in detail below.

FIG. 2 is a sectional view of a recess-type thin-film piezoelectric optical modulator.

Referring to FIG. 2, the recess-type thin-film piezoelectric optical modulator includes a silicon substrate 201 and elements 210.

In this case, the elements 210 may have a uniform width, may be regularly arranged, and may form the recess-type thin-film piezoelectric optical modulator. Alternatively, such elements 210 may have different widths, may be alternately arranged, and may form the recess-type thin-film piezoelectric optical modulator. The elements 210 may be spaced apart from each other by a predetermined interval (almost the same as the width of the elements 210), in which case the micromirror layer formed over the entire surface of the silicon substrate 201 diffracts incident light by reflecting the incident light.

The silicon substrate 201 has a recess for providing an air space to each element 210, an insulating layer 202 is deposited on the top surface of the silicon substrate 201, and both sides of the element 210 are attached to both sides of the silicon substrate 201 outside the recess.

Each element 210 is formed in a bar shape. Both sides of the element 210 are attached to both sides of the silicon substrate 201 outside the recess of the silicon substrate 201 so that the central portion of the element 210 is located over the recess of the silicon substrate 201. The element 210 includes a lower support 211, a portion thereof that is located over the recess of the silicon substrate 201 being able to move vertically.

Each element 210 includes a lower electrode layer 212 placed on the left side of the lower support 211 and adapted to provide piezoelectric voltage, a piezoelectric material layer 213 placed on the lower electrode layer 212 and adapted to generate a vertical actuating force through shrinkage and expansion thereof when voltage is applied to both sides thereof, and an upper electrode layer 214 placed on the piezoelectric material layer 213 and adapted to provide piezoelectric voltage to the piezoelectric material layer 213.

The element 410 further includes a lower electrode layer 212′ placed on the right side of the lower support 211 and adapted to provide piezoelectric voltage, a piezoelectric material layer 213′ placed on the lower electrode layer 212′ and adapted to generate a vertical actuating force through the shrinkage and expansion thereof when voltage is applied to both sides thereof, and an upper electrode layer 214′ placed on the piezoelectric material layer 213′ and adapted to provide piezoelectric voltage to the piezoelectric material layer 213′.

FIG. 5 is a block diagram showing the construction of a display system using a single-panel diffractive optical modulator, which has a function of reducing power consumption, according to an embodiment of the present invention.

Referring to FIG. 5, the display system using a single diffractive optical modulator, which has a function of reducing power consumption, according to the embodiment of the present invention, includes a display optical system 302 and a display electronic system 304.

The display optical system 302 includes red, green and blue laser light sources 306R, 306G and 306B, an illumination optical unit 308 for forming linear light to radiate light, emitted from the laser light sources 306R, 306G and 306B, onto a diffractive optical modulator 310 in an elliptical, narrow and long-line form, the diffractive optical modulator 310 for generating diffracted light by modulating the linear light radiated from the illumination optical unit 308, a Schlieren optics unit 314 for separating the diffracted light, which is generated by the diffractive optical modulator 310 and has a plurality of diffraction orders, according to diffraction order, and passing diffracted light having a desired diffraction order, selected from a plurality of beams of light having respective diffraction orders, therethrough, a scanning optical unit 316 for condensing diffracted light passing through the Schlieren optics unit 314, and linearly scanning the condensed diffracted light, a projection optical unit 317 for projecting the diffracted light, passing through the scanning optical unit 316, onto a display screen 318, and the display screen 318.

The display electronic system 304 is connected to the laser light sources 306R, 306G and 306B, the diffractive optical modulator 310 and the scanning optical unit 316.

The power source unit (not shown) of the display electronic system 304 supplies power to the laser light sources 306R, 306G and 306B. The laser light sources 306R, 306G and 306B radiate laser light, the cross section of which is circular and the intensity profile of which has Gaussian distribution.

Next, the illumination optical unit 308 converts the laser light, emitted from the laser light sources 306R, 306G and 306B, into linear light having an elliptical, narrow and long-line shape, and condenses the laser light onto the diffractive optical modulator 310.

When linear light having an elliptical, narrow and long-line shape is incident from the illumination optical unit 308, the diffractive optical modulator 310 generates diffracted light by modulating incident linear light under the control of the drive IC 407 of the display electronic system 304, and emits the diffracted light.

Thereafter, when diffracted light having a plurality of diffraction orders enters the Schlieren optics unit 312, the Schlieren optics unit 312 selectively passes diffracted light having a desired diffraction order therethrough. The Schlieren optics unit 312 includes, for example, a Fourier lens (not shown), and a spatial filter or dichroic filter (not shown). The Schlieren optics unit 312 selects one of 0-order diffracted light and ±1-order diffracted light from the incident diffracted light, and passes the selected diffracted light therethrough.

The scanning optical unit 316 includes a condensing lens (not shown) and a scanning mirror (not shown). The scanning optical unit 316 generates a color image by linearly scanning incident diffracted light across the display screen 318 under the control of the display electronic system 304. That is, the scanning optical unit 316 generates a color image by displaying a line image, which is incident through the spatial filter or dichroic filter and is composed of a plurality of pixels, on the display screen 318 while scanning the line image.

The projection optical unit 317 is a projection lens, and projects the image, linearly scanned by the scanning mirror (not shown), onto the screen 318.

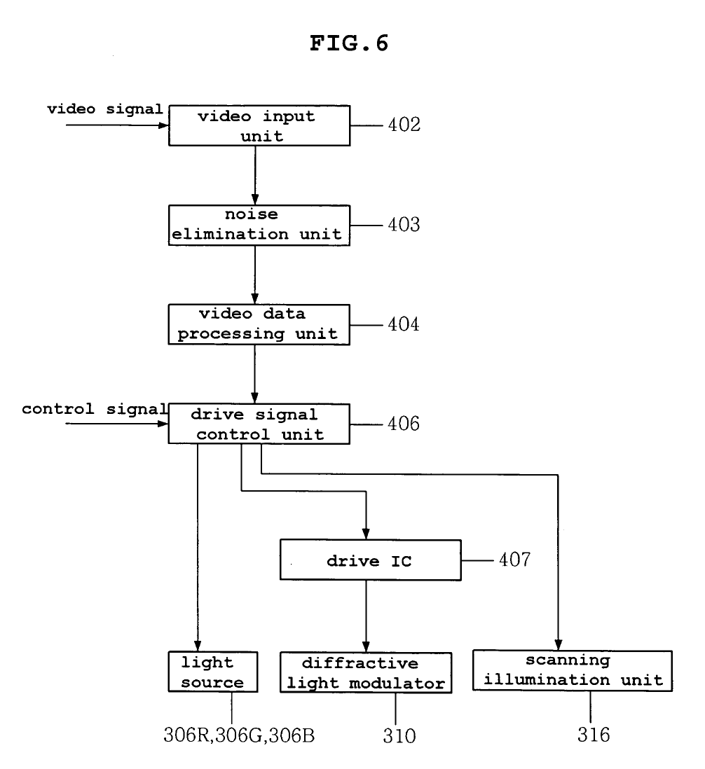

Meanwhile, the display electronic system 304, as shown in FIG. 6, includes a video input unit 402, a noise elimination unit 403, a video data processing unit 404, a drive signal control unit 406, and a drive IC 407.

The video input unit 402 receives video data from the outside. The noise elimination unit 403 eliminates salt and pepper noise from the video data, and outputs the video data free from noise. The video data processing unit 404 converts laterally arranged video data into vertically arranged video data by performing a data transposition operation of converting laterally arranged video data into vertically arranged data, thereby outputting the resulting data. The reason why data transposition is required in the video data processing unit 404 is that the diffractive optical modulator 310 is provided with a plurality of vertically arranged pixels, therefore lateral scanning and display must be performed.

In this case, salt and pepper noise is high frequency noise. The salt and pepper noise is generated due to various sources, such as the loss of data, the addition of an unnecessary external noise component, and problems with an image capturing device, and causes spot noise on the display screen 318. Furthermore, the salt and pepper noise causes a rapid increase in transistor switching current at the drive IC 407, thus resulting in an increase in power consumption. Accordingly, the noise elimination unit 403 compares input signals with adjacent signals for respective pixels, determines that noise has been generated if there is an abrupt change, eliminates the noise, and outputs the input signals free from noise. In this case, an example of a method by which the noise elimination unit 403 detects the generation of noise includes a method of using a sub mask, performing a predetermined operation on input video data and the sub mask, and determining that salt and pepper noise exists if the value of the result of the operation exceeds a specific threshold value. The method by which the noise elimination unit 403 eliminates noise includes a method of changing the value of the video signal of a corresponding pixel where noise exists to the value of an adjacent video signal or the average value of adjacent video signals. When the noise elimination unit 403 detects noise and outputs video free from noise as described above, the transistor switching current of the drive IC 407 is reduced, and therefore total power consumption can be reduced. In particular, the display system using the diffractive optical modulator 310 has one-dimensional line scan characteristics, therefore the sub mask is constructed in a 1×N configuration.

Meanwhile, when a projection control signal requesting the performance of a projection function is input from the outside, the drive signal control unit 406 receives laterally data-transposed video data from the video data processing unit 404, and controls the diffractive optical modulator 310 through the light sources 306R, 306G and 306B and the drive IC 407, thus forming video using diffracted light.

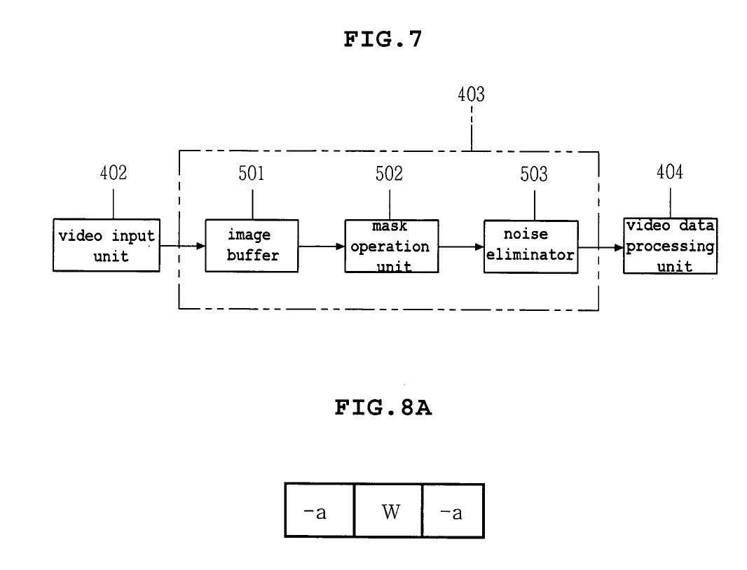

FIG. 7 is a block diagram showing the internal construction of the noise elimination unit of FIG. 6, which includes an image buffer 501, a mask operation unit 502, and a noise eliminator 503.

The image buffer 501 buffers video input from the video input unit 402, so the following mask operation unit 502 can perform operations using the sub mask.

In this case, the image buffer 501 performs buffering for three colors, that is, red, blue and green.

The mask operation unit 502 performs operations using the sub mask, in which case the sub mask is constructed in a 1×N configuration because the display device using the diffractive optical modulator has one-dimensional line scan characteristics.

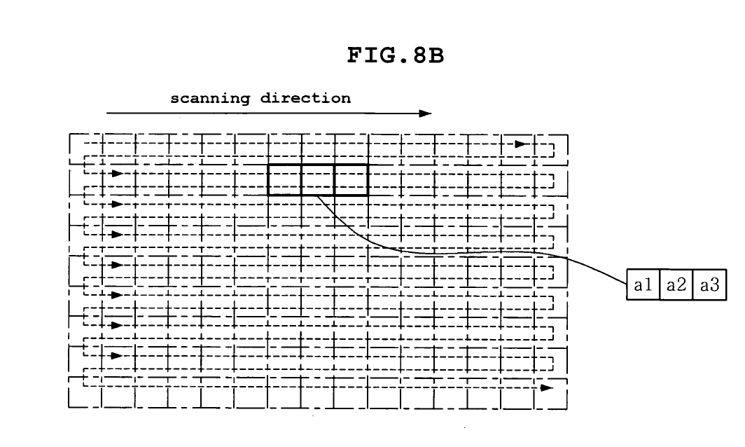

An example of the sub mask that can be used by the mask operation unit 502 is illustrated in FIG. 8A. The example is configured to have a weight factor W at the center thereof, and to have a value —a on each of the two sides thereof. Preferably, the value of “a” is 1. The value of this weight factor may be arbitrarily determined. The sub mask shown in FIG. 8A is a sub mask having a basic shape, and the shape of the sub mask noise may vary with the characteristic of the noise.

Meanwhile, the operations performed by the mask operation unit 502 are performed on, for example, three horizontal pixels, in the case where the sub mask of FIG. 8A is used.

That is, operations are performed in steps of three pixels while moving the sub mask in a scan direction, as shown in FIG. 8B. When, for example, an operation is performed on three pixels a1, a2 and a3, the value of the result of the operation is R=W*a2−a1−a3. The value of the result of the operation shows the difference between the value of a center pixel and the values of adjacent pixels when the value of the center pixel is compared with the values of the adjacent pixels. If the value of “W” is appropriately set, salt and pepper noise can be eliminated to some extent. Of course, in this case, the operation equation may be set to RI=W*a2−a1 or R2=W*a2−a3.

In this case, the mask operation unit 502 may select one from among operation equations R, RI and R2 and perform operations using the selected operation equation, or may select two or three from among them. The dotted arrows of FIG. 8B represent the sequence in which operations are performed.

Thereafter, when the mask operation unit 502 performs an operation using the sub mask and outputs the value of the result of the operation, the noise eliminator 503 outputs the value of the center pixel if a specific condition is fulfilled, and converts the value of the center pixel to the value of an adjacent pixel and then outputs the resulting value if the specific condition is not fulfilled.

That is, as an example, the noise eliminator 503 maintains the original value a2 if the value of the result of the operation performed on the video data shown in FIG. 8B does not exceed a specific threshold value T, and converts the value a2 into the value a1 or value a3 if the value of the result of the operation exceeds the specific threshold value T.

Although the above-described condition has been applied to the values for operation equation R1, the above condition may be applied to R1 and/or R2.

That is, one or more may be selected from among operation equations R, R1 and R2, it may be determined that an abrupt change in video signal has been generated if a corresponding value exceeds a specific threshold value, and then noise may be eliminated from the video signal.

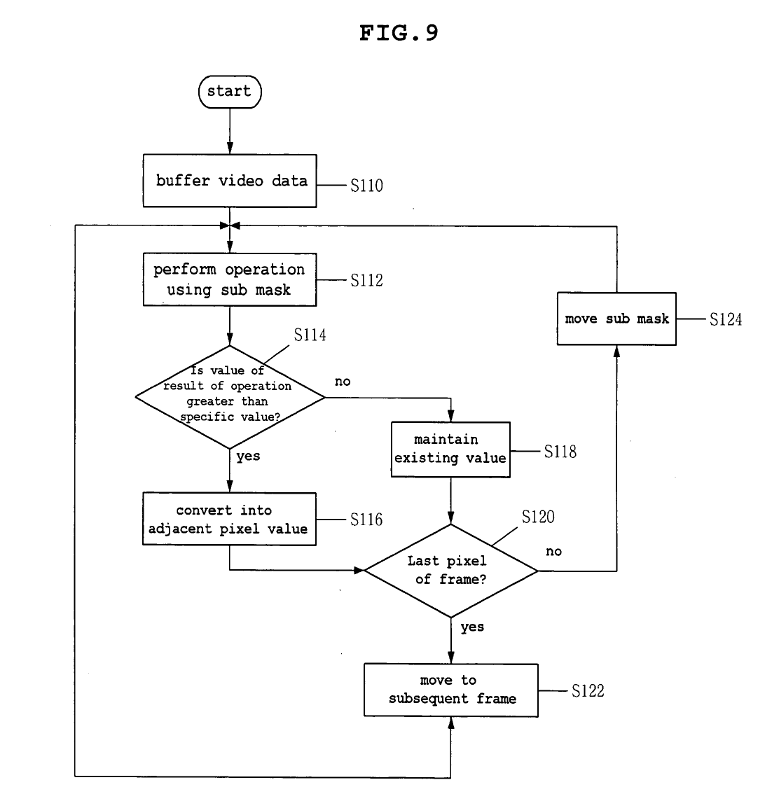

FIG. 9 is a flowchart showing the noise elimination process of the noise elimination unit of FIG. 6. First, the image buffer buffers video input from the video input unit, so the following mask operation unit can perform operations using the sub mask at step S110.

The mask operation unit performs operations using the sub mask and outputs the values of the results of the operations to the noise eliminator at step S112.

Thereafter, the noise eliminator determines whether the value of the result of each operation is greater than a specific value at step S114, and converts the value of a center pixel to the value of an adjacent pixel at step S116. Thereafter, the noise eliminator determines whether a corresponding pixel is the last pixel of a corresponding frame, and moves the sub mask at step S124 and then repeats the steps starting from step S112 if the corresponding pixel is not the last pixel, and moves to the next frame at step S122 and then performs the steps starting from step S112 if the corresponding pixel is the last step.

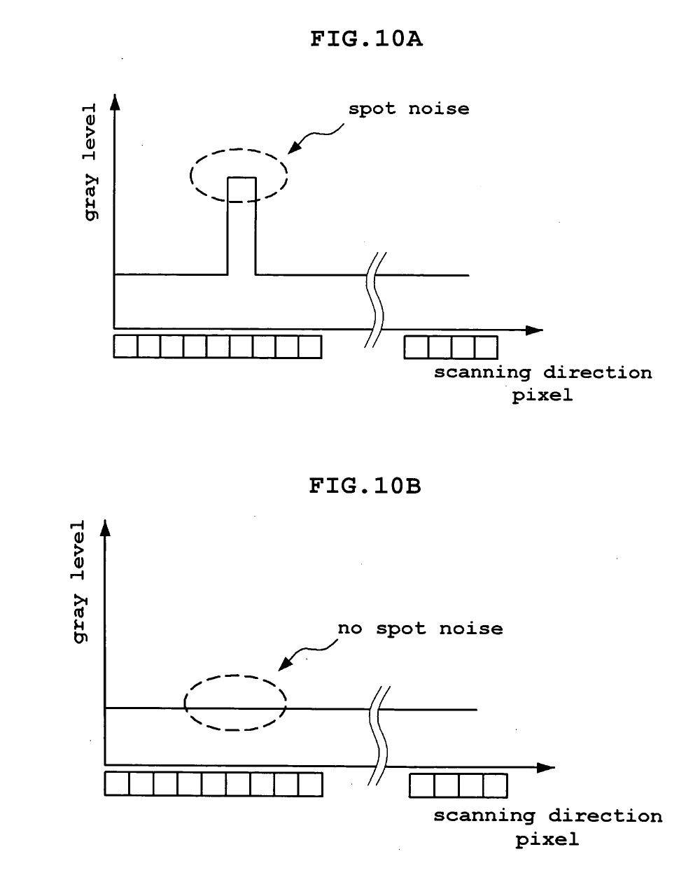

FIGS. 10A and 10B are diagrams showing the elimination of noise according to an embodiment of the present invention.

Referring to FIG. 10A, a gray level is maintained at a specific value for a pixel value along a specific row in a scanning direction, and then is abruptly increased at a specific time point. If so, a rapid switching operation is required at the switching transistor, therefore average digital power consumption is significantly increased on the basis of effective current. In contrast, referring to FIG. 10B, noise has been eliminated so that a uniform gray level can be maintained for a pixel value along a specific row in a scanning direction, therefore a rapid switching operation is not required, with the result that a rapid increase in average digital power consumption is not required on the basis of effective current.

As described above, according to the present invention, transistor switching current can be reduced at the drive IC by constructing a one-dimensional sub mask in a direction identical to a video scanning direction and eliminating salt and pepper noise through operations using input video and the sub mask, thereby achieving a reduction in total power consumption.

Furthermore, according to the present invention, noise introduced through a transmission or reception path, video encoding or decoding, which exist in the video processing of a portable terminal, can be eliminated, thereby achieving the improvement of video quality.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A device for reducing power consumption in a display system using a diffractive optical modulator, comprising:
a video input unit for receiving video signals;
a noise elimination unit for eliminating noise from the video signals and then outputting noise-free video signals when the video signals are input from the video input unit;
a drive signal control unit for outputting drive control signals for driving a diffractive optical modulator in response to the video signals input from the noise elimination unit; and
a drive Integrated Circuit (IC) for outputting drive signals for driving a diffractive optical modulator and thus generating video images when the drive control signals of a diffractive optical modulator are input from the drive signal control unit.

2. The device as set forth in claim 1, further comprising a video data processing unit for data-transposing the video signals input from the noise elimination unit, and outputting the data-transposed video data to the drive signal control unit.

3. The device as set forth in claim 1, wherein the noise eliminated by the noise elimination unit is high-frequency noise.

4. The device as set forth in claim 1, wherein the noise eliminated by the noise elimination unit is salt and pepper noise.

5. The device as set forth in claim 1, wherein the noise elimination unit compares a value of each pixel with a value of an adjacent pixel for the video signals input from the video input unit, and determines that noise exists and then eliminates the noise if a comparison result exceeds a specific threshold value.

6. The device as set forth in claim 5, wherein the noise elimination unit constructs a one-dimensional sub mask in a scanning direction for the video signals input from the video input unit, performs operations using the sub mask, and determines that noise exists and then eliminates the noise if a value of an operation for each pixel exceeds the specific threshold value.

7. The device as set forth in claim 6, wherein the noise elimination unit comprises:
an image buffer for buffering the video signals input from the video input unit;
a mask operation unit for constructing the one-dimensional sub mask in the scanning direction for the video signals buffered by the image buffer, performing operations using the sub mask, and outputting a value of an operation for a corresponding pixel; and
a noise eliminator for determining that noise exists and then eliminating the noise if the value of the operation for each pixel exceeds the specific threshold value.

8. The device as set forth in claim 7, wherein the sub mask used by the mask operation unit is a mask having a 1×configuration, the mask having a positive weight factor at a center portion thereof, and negative operators at sides thereof.

9. The device as set forth in claim 7, wherein the noise eliminator determines that noise exists and then replaces the value of the pixel with the value of the adjacent pixel if the value of the result of the operation for the pixel exceeds the specific threshold value.
